(19) United States
(12) Patent Application Publication
(10) Pub. No.: US 2004/0136063 A1
(43) Pub. Date: Jul. 15, 2004

(54) Telescope

(76) Inventor: William T. Yang, Hsintien City (TW)

Correspondence Address: RABIN & BERDO, P.C., Suite 500, 1101 14th Street, Washington, DC, 20005, US

(21) Appl. No.: 10/342,192

(22) Filed: Jan. 15, 2003

(51) Int. Cl. G02B 23/00

(52) U.S. Cl. 359/410; 359/399; 359/425

(57) ABSTRACT

A telescope includes a main tube having an objective lens and an eyepiece, and a focuser located between the objective lens and the eyepiece; a mode switching mechanism located in front of the eyepiece and including an external switch lever and an internal flip mirror fixedly connected to the switch lever; a digital image store device located behind the main tube for receiving and processing incoming video and audio signals, storing the processed signals on a memory, and displaying the video signals on a liquid crystal display; and a focusing control device located between the main tube and the digital image store device. By operating the switch lever, optical axes of the telescope and the digital image store device can be brought to parallel with each other for the digital image store device to receive and record images exactly the same as those being viewed with the telescope.

### BACKGROUND OF THE INVENTION

The present invention relates to a telescope, and more particularly to a digital telescope having a digital image store device and a mode switching mechanism associated therewith.

The telescope has always played an important role of extending human vision since Galileo invented it. There are also various inventions made by employing the principle of telescope and been used in our daily life, recreational activities and works, and even in scientific researches. The conventional telescope has very simple structure and basically includes an objective lens and an eyepiece for directly forming a positive image. It is known that the telescope has a magnifying power equal to a ratio of the focus of objective lens to the focus of eyepiece. However, as a matter of fact, the telescope includes many other parameters that are not independent of one another but are interrelated. Since the setting of these parameters involves in complicate optical engineering calculation, it is not discussed herein.

U.S. Pat. No. 6,088,053 entitled Digital Record and Replay Binoculars discloses a binoculars 12 having a digital video camera 15 mounted between two tubes of the binoculars 12. The binoculars 12 with the digital video camera 15 allows a user not only to view interesting things with the binoculars 12 in a conventional manner, but also to record views and store the same on a memory provided in the digital video camera 15. However, pictures taken and recorded by the digital video camera 15 is in the form of analog signals and have lower pixels about 100 to 350 thousands of pixels, and therefore have inferior image quality and low resolution.

Even if a user has used the binoculars 12 to view interesting things and record the viewed things with the digital video camera 15 to produce a video tape, he or she may still have to pick out from the video tape one or more specific and interesting pictures and try to print these pictures. This is, of course, troublesome for the user to do so. In fact, the recording of specific and interesting views or scenes can be easily achieved simply by using a high-pixel digital camera. Moreover, a digital camera provides a store device that can store multiple pictures showing images that are considered specific and interesting by the user. On the other hand, the binoculars 12 disclosed in U.S. Pat. No. 6,088,053 employs the digital video camera 15 to continuously record interesting images and requires a large capacity of memory to store the recorded images, which is not an economical design in terms of production cost and useful effect thereof.

### SUMMARY OF THE INVENTION

It is a primary object of the present invention to provide a telescope that is integrated with existing digital electronic and optical technologies to include a digital image store device and a mode switching mechanism, so that the telescope may be produced at reduced cost while providing good image quality for use in observation of universe phenomenon, including nebula, star cluster, star dust, etc., or in observation of other distant moving targets for an extended time period.

Another object of the present invention is to provide a digital telescope that is associated with digital image store device and audio signal receiving means for viewing while recording distant things and surrounding sounds.

To achieve the above and other objects, the telescope of the present invention mainly includes a main tube having an objective lens and an eyepiece, and a focuser located between the objective lens and the eyepiece; a mode switching mechanism located in front of the eyepiece and including an external switch lever and an internal flip mirror fixedly connected to the switch lever; a digital image store device located behind the main tube and the flip mirror for receiving and processing video and audio signals, storing the processed signals on a memory, and displaying the video signals on a liquid crystal display; and a focusing control device located between the main tube and the digital image store device. By operating the switch lever, optical axes of the digital telescope and the digital image store device can be brought to parallel with each other for the latter to take and record images exactly the same as those being viewed with the telescope.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of the telescope according to an embodiment of the present invention;

FIG. 2 is an exploded perspective view of FIG. 1;

FIG. 3 is another assembled perspective view of the telescope of FIG. 1;

FIG. 4 is a schematic plan view showing a mode switching mechanism and a digital image store device included in the telescope of the present invention, with a flip mirror of the mode switching mechanism in an inclined position;

FIG. 5 is another schematic plan view similar to FIG. 4, with the flip mirror of the mode switching mechanism in a flat position;

FIG. 6 is a further schematic plan view similar to FIG. 4, with the flip mirror of the mode switching mechanism in an inclined position and an eyepiece of the telescope in a corresponding inclined position;

FIG. 7 is a schematic view of a focusing control wheel included in the present invention;

FIG. 8 is a perspective view of a telescope according to a second embodiment of the present invention;

FIG. 9 is a schematic plan view showing a structure of the telescope of FIG. 8;

FIG. 10 is a schematic plan view showing a structure of a telescope according to a third embodiment of the present invention;

FIG. 11 is a block diagram showing electronic circuits for the present invention; and

FIG. 12 is a plan view of a sighting cross included in the present invention.

### DETAILED DESCRIPTION OF THE PREFERRED EMBODIMENTS

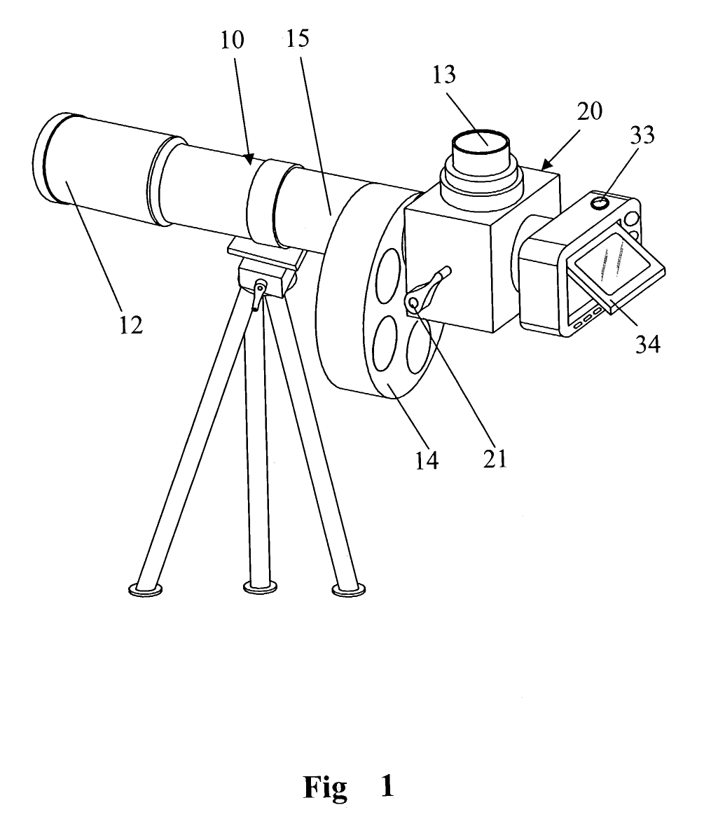

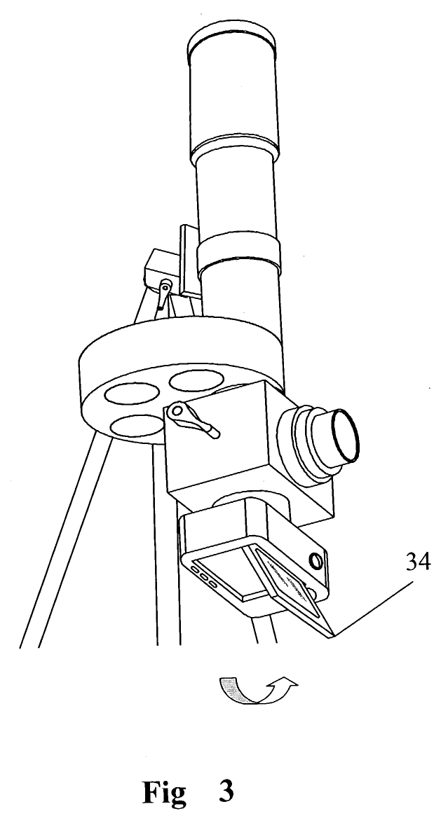

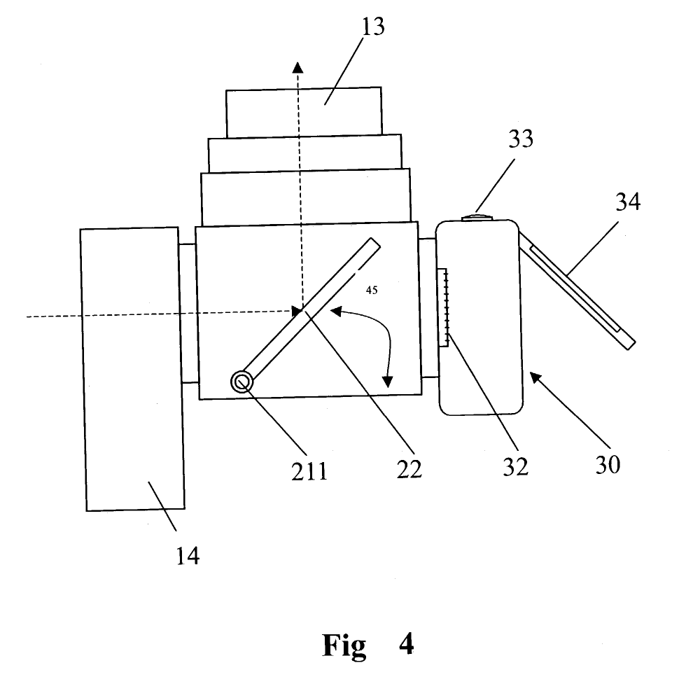

Please refer to FIGS. 1 to 3. The present invention generally relates to a digital telescope 10 having a mode switching mechanism 20 and a digital image store device 30 associated therewith. The digital telescope 10 mainly includes a main tube 11, an objective lens 12, an eyepiece 13, a focusing control wheel 14, and a focuser 15. When the digital telescope 10 is used in a conventional manner, an optical image of a distant target view is projected through the objective lens 12, the focuser 15, and the focusing control wheel 14, and then reflected by an internal flip mirror 22 (see FIG. 4) to the eyepiece 13, at where a user may see the distant target view.

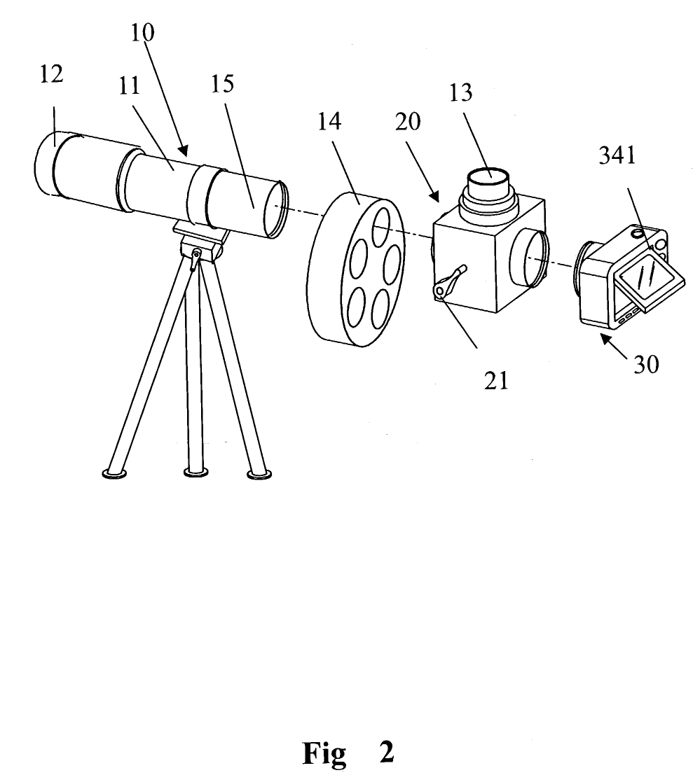

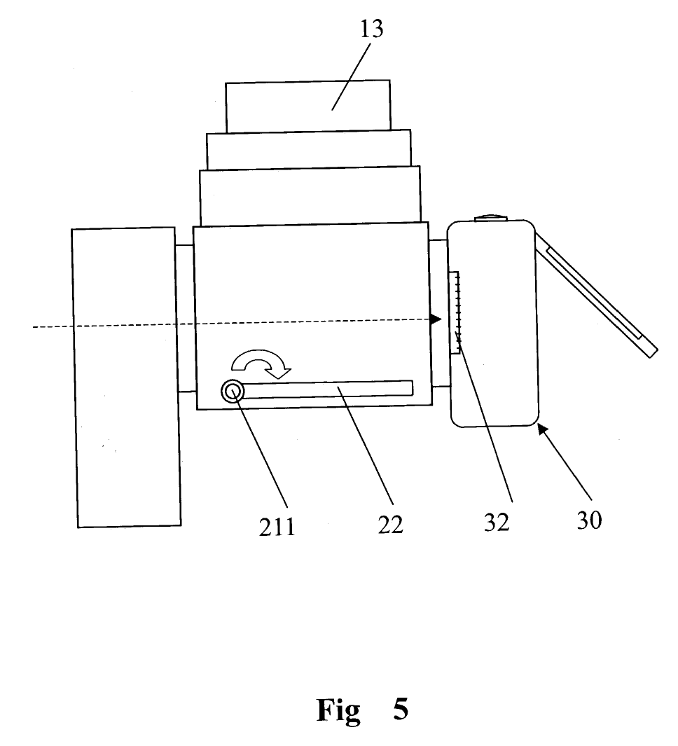

The mode switching mechanism 20 and the digital image store device 30 are connected to the main tube 11 of the digital telescope 10 at predetermined positions. Please refer to FIGS. 4 to 6. The mode switching mechanism 20 includes an external switch lever 21 for switching the digital telescope 10 between a first and a second viewing mode. In the first viewing mode, the digital telescope 10 is used in the above-mentioned conventional manner and the flip mirror 22 is in an inclined position between 22.5 and 45 degrees. When the digital telescope 10 is switched to the second viewing mode, the flip mirror 22 is in a flat position without reflecting the optical image of the distant target view projected through the objective lens 15, the focuser 15, and the focusing control wheel 14, as shown in FIG. 5. When a shutter release 33 externally provided on the digital image store device 30 (see FIG. 4) is depressed, the optical image of the distant target view projected through the focusing control wheel 14 is directly read by a CCD (charge-coupled device) type image sensor 31 or a CMOS (complementary metal-oxide semiconductor) type photoelectrical signal converter 32 of the digital image store device 30. After being driven by a CCD-type image drive 311 or a CMOS-type image drive 321, the read optical image of the distant target view is output to display on a liquid crystal display (LCD) 34 of the digital image store device 30. The LCD 34 is pivotally connected to the digital image store device 30 via a pivotal shaft 341 (see FIG. 2) so that a user may turn the LCD 34 about the pivotal shaft 341 within a range from zero to 180 degrees to an adequate inclination most comfortable for viewing.

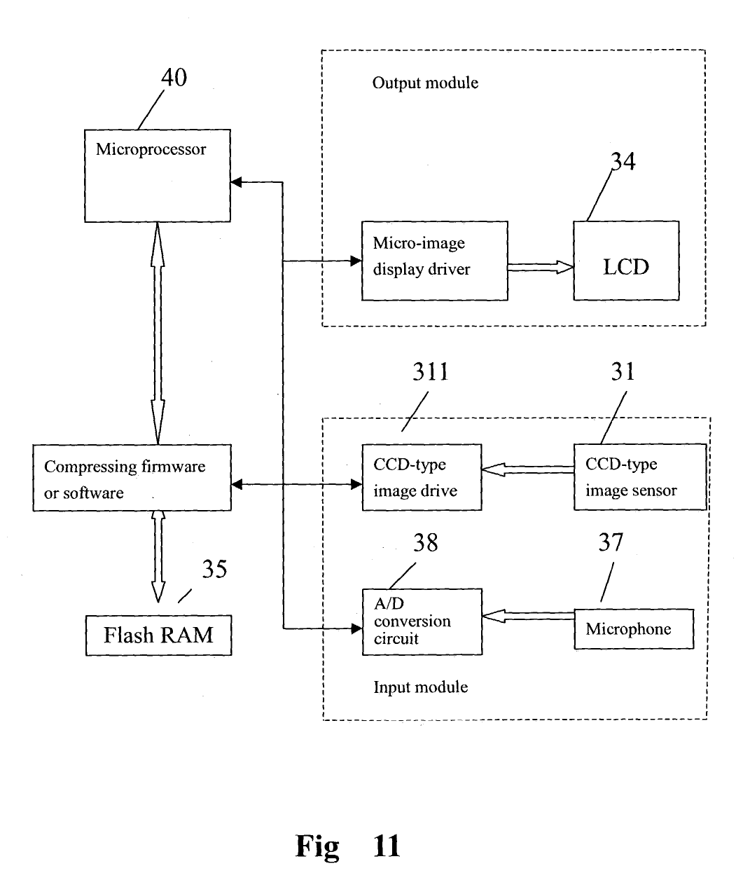

Please refer to FIG. 11 that is a block diagram showing electronic circuits and accordingly operations and functions of the digital image store device 30 of the present invention. As shown, the digital image store device 30 includes the functions of:

1. Receiving incoming video and audio signals: This function is performed through a CCD-type image sensor 31 or a CMOS-type photoelectrical signal converter 32, and a microphone 37;

2. Processing incoming video and audio signals: This function is performed through a CCD-type image drive 311 or a CMOS-type image drive 321, an analog/digital conversion circuit 38, and a microprocessor 40;

3. Storing video/audio signals: This function is performed through a semiconductor memory 35, such as a flash random access memory (flash RAM) or a static random access memory (SRAM); and

4. Displaying images: This function is performed through a LCD 34 that is located on one optical axis of the digital telescope 10.

Please refer to FIG. 4. When the digital telescope 10 is switched to the first viewing mode for use in the conventional manner, the optical image of the distant target view is reflected by the flip mirror 22 to the eyepiece 13 and seen by a user at the eyepiece 13. The flip mirror 22 is internally connected to a pivotal shaft 211 of the switch lever 21. When the switch lever 21 is pushed to switch the digital telescope 10 to the second viewing mode, the pivotal shaft 211 is brought to turn by an angle at the same time, and the flip mirror 22 connected to the pivotal shaft 211 is also caused to turn by an identical angle to a flat position, as shown in FIG. 5. The flip mirror 22 in this flat position does not reflect the optical image of the distant target view, allowing the optical image to be directly read by the CCD-type image sensor 31 or the CMOS-type photoelectrical signal converter 32. Please refer to FIG. 11. After being driven by the CCD-type image drive 311 or the CMOS-type image drive 321, the optical image of the distant target view is output to display on the LCD 34. The output image may be adjusted according to actual need to display on the LCD 34 in a vertically or horizontally reversed position when a corresponding program instruction is given.

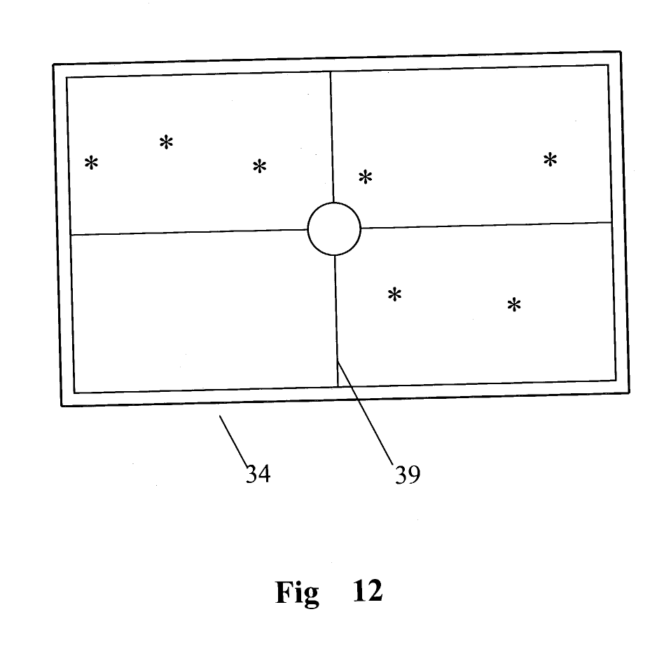

Both the CCD-type image drive 311 and the CMOS-type image drive 321 of the digital image store device 30 are able to produce a color and bright variable sighting cross 39 on the LCD 34 through program instructions, as shown in FIG. 12. Moreover, a requirement for adjustment of Red, Green, and Blue colors of the displayed image may be satisfied through programming. Advanced technologies make video recording more interesting and attractive than photograph, which appears in the form of single sheet and shows static and monotonous image, particularly in the case of, for example, recording continuous changes in a meteoric stream, solar eclipse, lunar eclipse, etc. Therefore, the present invention has been programmed to include a function of continuous photographing or recording. The duration of video recording depends on a capacity of the memory 35. The larger the capacity of the memory 35 is, the longer the duration of video recording may be.

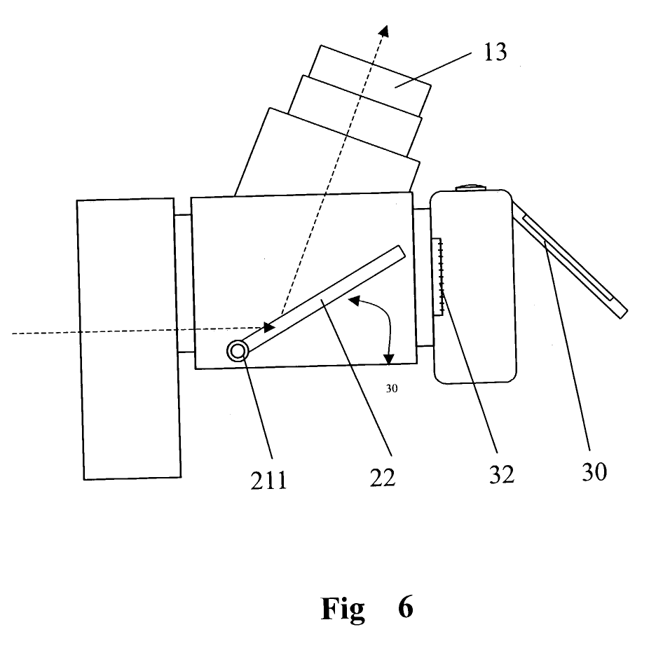

It is a known principle that an incident angle is equal to a corresponding reflection angle. In the present invention, this principle is employed. Please refer to FIGS. 6 and 11. When the digital telescope 10 is switched to the first viewing mode, the flip mirror 22 may be set to, for example, a 30-degree inclination while the eyepiece 13 is adjusted to a 60-degree inclination, allowing the user to view at the eyepiece 13 in a comfortable manner.

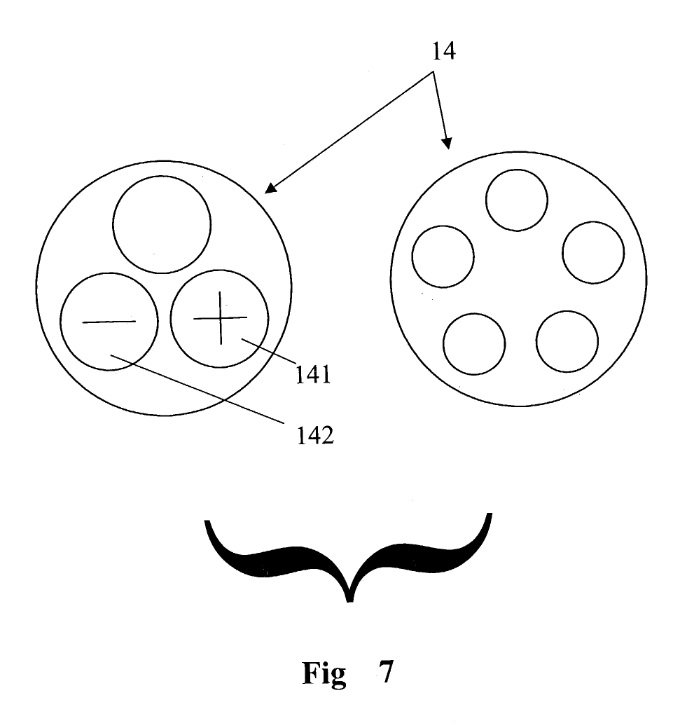

FIG. 7 is a plan view of the focusing control wheel 14 mounted on the digital telescope 10. As shown, the focusing control wheel 14 includes at least one focus-extending lens 141 and one focus-reducing lens 142, and a hole without any lens mounted thereto.

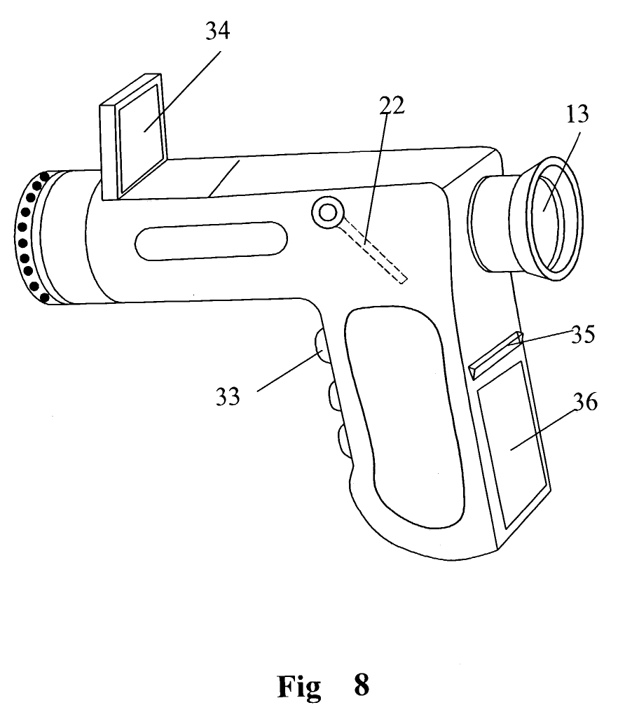

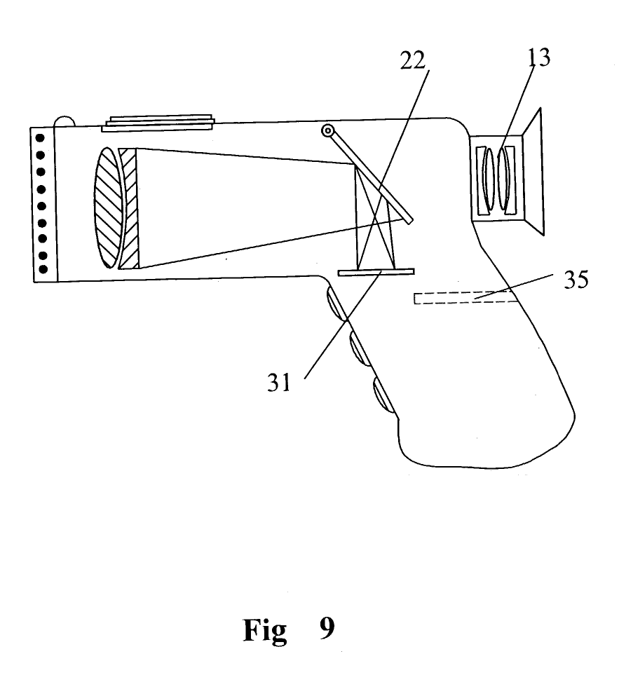

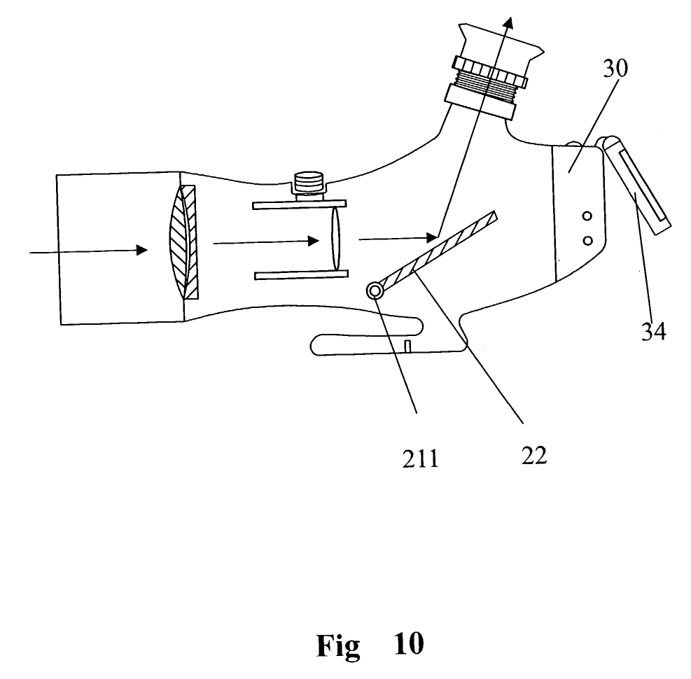

FIGS. 8 and 9 are perspective and schematic side views, respectively, of a hand-held telescope according to a second embodiment of the present invention, and FIG. 10 is a schematic side view of another hand-held telescope according to a third embodiment of the present invention. In these two embodiments, a flip mirror 22 is similarly used to achieve the switching of viewing mode for the hand-held telescope. When the hand-held telescope of FIG. 8 or 10 is switched to the second viewing mode and the shutter release 33 is depressed, the optical image of the distant target view can be stored in the memory 35. A battery 36 is included in the hand-held telescope to supply power required for the telescope to work.

The present invention has been described with some preferred embodiments thereof and it is understood that many changes and modifications in the described embodiments, such as mounting a cooling fan on the digital image store device 30, can be carried out without departing from the scope and the spirit of the invention as defined by the appended claims.

What is claimed is:

1. A telescope, comprising:
a main tube being provided at front and rear ends with an objective lens and an eyepiece, respectively, both of which are formed from optical lenses, and at a position between said objective lens and said eyepiece with a focuser;
a mode switching mechanism substantially located in front of said eyepiece at a predetermined position;
a digital image store device located behind said mode switching mechanism; and
a focusing control device located between said main tube and said digital image store device but before said eyepiece; and
said mode switching mechanism being operable to cause optical axes of said telescope and said digital image store device to parallel with each other, such that said digital image store device is able to receive images exactly the same as those viewed at said eyepiece of said telescope, enabling said telescope to be used not only for observation but also recording from a distant location.

2. The telescope as claimed in claim 1, wherein said digital image store device includes an image sensor, a photoelectric signal converter, a shutter release, a liquid crystal display (LCD), a microphone, an analog-to-digital conversion circuit, a microprocessor, a memory, and a battery.

3. The telescope as claimed in claim 2, wherein said mode switching mechanism includes a switch lever fixedly connected to an outer end of a pivotal shaft so as to be externally accessible, and a flip mirror fixedly connected to an inner end of said pivotal shaft so as to internally locate in front of said eyepiece.

4. The telescope as claimed in claim 2, wherein said microphone of said digital image store device is capable of receiving incoming audio signals and transmitting said received audio signals to said analog-to-digital conversion circuit for converting said received audio signals into digital signals, said microprocessor is capable of receiving and processing said digital signals transmitted thereto by said analog-to-digital conversion circuit, and said memory is capable of storing said digital signals processed and transmitted thereto by said microprocessor.

5. The telescope as claimed in claim 3, wherein said switch lever of said mode switching mechanism is operable to switch said telescope between a first viewing mode, in which said flip mirror is turned to an inclination for reflecting an optical image of a distant target view to said eyepiece without displaying said optical image on said LCD of said digital image store device, and a second viewing mode, in which said flip mirror is turned to a flat position, so that said optical image of said distant target view is not reflected by said flip mirror but directly displayed on said LCD.

6. The telescope as claimed in claim 5, wherein said image sensor and said photoelectric signal converter of said digital image store device are capable of receiving and/or recording incoming video signals and said microphone of said digital image store device is capable of receiving and/or recording incoming audio signals when said telescope is switched to said second viewing mode, and wherein said received and/or recorded video and audio signals may be stored on said memory of said digital image store device.

7. The telescope as claimed in claim 6, wherein said video signals received by said image sensor are displayed on said LCD through driving of an image drive included in said digital image store device.

8. The telescope as claimed in claim 6, wherein said video signals received by said photoelectric signal converter are displayed on said LCD through driving of an image drive included in said digital image store device.

9. The telescope as claimed in claim 5, wherein said inclination for said flip mirror is within a range from 22.5 to 45 degrees.

10. The telescope as claimed in claim 2, wherein said LCD of said digital image store device is pivotally turnable up to 180 degrees.

11. The telescope as claimed in claim 7, wherein said image drive is a charge-coupled device (CCD) type image drive.

12. The telescope as claimed in claim 8, wherein said image drive is a complementary metal-oxide semiconductor (CMOS) type image drive.

13. The telescope as claimed in claim 7, wherein said image drive is programmable so as to show a sighting cross on said LCD when a corresponding program instruction is given to said image drive.

14. The telescope as claimed in claim 7, wherein said image drive is programmable so as to display said video signal on said LCD in a vertically or horizontally reversed position when a corresponding program instruction is given to said image drive.

15. The telescope as claimed in claim 7, wherein said image drive is programmable so as to adjust red, green and blue colors of said video signals displayed on said LCD when a corresponding program instruction is given to said image drive.

16. The telescope as claimed in claim 8, wherein said image drive is programmable so as to show a sighting cross on said LCD when a corresponding program instruction is given to said image drive.

17. The telescope as claimed in claim 11, wherein said image drive is programmable so as to show a sighting cross on said LCD when a corresponding program instruction is given to said image drive.

18. The telescope as claimed in claim 12, wherein said image drive is programmable so as to show a sighting cross on said LCD when a corresponding program instruction is given to said image drive.

19. The telescope as claimed in claim 8, wherein said image drive is programmable so as to display said video signal on said LCD in a vertically or horizontally reversed position when a corresponding program instruction is given to said image drive.

20. The telescope as claimed in claim 11, wherein said image drive is programmable so as to display said video signal on said LCD in a vertically or horizontally reversed position when a corresponding program instruction is given to said image drive.

21. The telescope as claimed in claims 12, wherein said image drive is programmable so as to display said video signal on said LCD in a vertically or horizontally reversed position when a corresponding program instruction is given to said image drive.

22. The telescope as claimed in claim 8, wherein said image drive is programmable so as to adjust red, green and blue colors of said video signals displayed on said LCD when a corresponding program instruction is given to said image drive.

23. The telescope as claimed in claim 11, wherein said image drive is programmable so as to adjust red, green and blue colors of said video signals displayed on said LCD when a corresponding program instruction is given to said image drive.

24. The telescope as claimed in claim 12, wherein said image drive is programmable so as to adjust red, green and blue colors of said video signals displayed on said LCD when a corresponding program instruction is given to said image drive.
